(19) United States
(12) Patent Application Publication
(10) Pub. No.: US 2026/0078034 A1
(43) Pub. Date: Mar. 19, 2026

(54) Active Oxygen Water Dispensers

(71) Applicant: AS America, Inc., Piscataway, NJ (US)

(72) Inventors: Alison J. Lyons, New York, NY (US); Lydia Swedberg, Meredith, NH (US); Ki Bok Song, Plainview, NY (US)

(73) Assignee: AS America, Inc., Piscataway, NJ (US)

(21) Appl. No.: 19/108,532

(22) PCT Filed: Aug. 24, 2023
(86) PCT No.: PCT/US2023/072802

§ 371 Date: Mar. 4, 2025

Related U.S. Application Data
(60) Provisional application No. 63/406,140, filed on Sep. 13, 2022.

(51) Int. Cl. C02F 1/78; C02F 1/00

(52) U.S. Cl. CPC C02F 1/78; C02F 1/008; C02F 2201/005; C02F 2201/782; C02F 2209/008; C02F 2303/04; C02F 2307/06; E03C 2201/40

(57) ABSTRACT

Provided herein are active oxygen water dispensers embodied in kitchen faucets and side sprayers for dispensing an active oxygen water supply. The faucet body comprises a lock, water outlet, and controller, wherein the lock and controller are disposed on a first portion of the faucet body, and the controller is configured to detect a user requesting active oxygen water to be dispensed from the faucet body. The active oxygen water dispensers comprise one or more valves fluidly connected to the faucet body and configured to allow an active oxygen water supply to be dispensed; wherein, when the lock is in an unlocked position and the controller detects the user input, the one or more valves is actuated to an open position to allow the faucet body to dispense the active oxygen water supply from the water outlet.

### CROSS-REFERENCE TO RELATED APPLICATION

This application claims the benefit of U.S. Provisional Application No. 63/406,140, filed Sep. 13, 2022, the entire contents of which is incorporated herein by reference.

### FIELD

The present disclosure generally relates to kitchen sink fluid dispensers, and in particular, to kitchen sink faucets and side sprayers for dispensing an active oxygen water supply.

### BACKGROUND

Conventional kitchen faucets and side sprayers are configured to deliver water from a hot water supply and/or cold water supply towards a kitchen sink. The dispensed tap water is traditionally from a well water source or municipal water source and is therefore unenhanced and unfiltered.

### SUMMARY

Provided herein are active oxygen water dispensers (e.g., faucets and side sprayers) for dispensing active oxygen water (e.g., ozone-infused water, ozonated water, etc.) in addition to and/or in place of tap water (e.g., unenhanced water) from a municipal or well water supply. The active oxygen water dispensers described herein can be optionally controlled in a touchless manner that allows the user to interact with the faucet hands-free and thus improves workflow in the kitchen, reduces the risk of cross-contamination (e.g., while working with raw meat/fish), and minimizes the spread of germs. Further, the active oxygen water dispensers described herein can communicate to a user the type of water being dispensed (e.g., active oxygen water or tap water) to minimize risk of user confusion during operation of the faucet and/or side sprayer.

As described above, conventional kitchen faucets and/or side sprayers (e.g., side spray devices) only dispense tap water from a main water supply. However, tap water is generally inadequate for use in sanitizing dirty/used kitchen utensils, surfaces, users' hands, etc. without the user manually adding a cleansing agent (e.g., dish soap, hand soap, surface disinfectant, etc.). Additionally, tap water is often inadequate in properly cleaning fresh produce prior to user consumption. Accordingly, the faucets and side sprayers disclosed herein may dispense active oxygen water for sanitizing surfaces, produce, kitchen tools, the kitchen sink, cleaning supplies (e.g., sponges, dish rags, etc.), and users' hands. Active oxygen water may reduce the presence of bacteria, pesticides, E. coli, salmonella, etc. in the kitchen. Furthermore, active oxygen water may sanitize and extend the life of produce rinsed with the supply, as well as remove potent food odors from hands, tools, and surfaces. Finally, active oxygen water may sanitize internal waterways of the faucet and/or the side sprayer each time the active oxygen water supply is activated and dispensed.

The active oxygen water dispensers provided herein may detect a user input at a controller and actuate at least one valve and/or activate an ozone generator to dispense active oxygen water. In some embodiments, the active oxygen water dispensers may only dispense the active oxygen water in accordance with a position of a lock on the faucet body and/or side sprayer (e.g., the lock must be unlocked). Based on a status of the lock, one or more illuminators (e.g., light indicators) on the faucet body and/or side sprayer may communicate to the user whether active oxygen water can be dispensed. In some embodiments, the user may engage with a touchless and/or touch-sensitive controller of the active oxygen water dispensers to allow and disallow the dispensing of active oxygen water from the faucet and/or side sprayer.

In some embodiments, a faucet for dispensing active oxygen water is provided, the faucet comprising: a faucet body comprising a lock, a water outlet, and a controller, wherein the lock is disposed on a first portion of the faucet body, and the controller is disposed on the first portion of the faucet body and configured to detect a user input requesting active oxygen water to be dispensed from the faucet body; and one or more valves fluidly connected to the faucet body and configured to allow an active oxygen water supply to be dispensed, wherein, when the lock is in an unlocked position and the controller detects the user input, the one or more valves is actuated to an open position to allow the faucet body to dispense the active oxygen water supply from the water outlet.

In some embodiments, the faucet comprises one or more processors communicatively coupled to the controller and the lock and configured to cause the one or more valves to be actuated to the open position when the one or more processors receive a signal indicating the user input and the lock is in the unlocked position.

In some embodiments, the one or more valves of the faucet are actuated to a closed position when the controller detects a second user input requesting active oxygen water to stop being dispensed.

In some embodiments, the faucet comprises one or more processors configured to cause the one or more valves to be actuated to the closed position when the one or more processors receive a signal indicating the second user input.

In some embodiments, the controller of the faucet comprises one or more capacitive sensors.

In some embodiments, the faucet comprises one or more receivers configured to receive a control signal comprising an instruction to adjust a capacitive field strength setting of a capacitive field generated at least in part by the one or more capacitive sensors.

In some embodiments, the capacitive field is adjustable between a high, medium, and low capacitive field strength setting.

In some embodiments, the controller of the faucet is touch-sensitive and configured to receive the user input at least when the capacitive field strength setting is adjusted to the low setting.

In some embodiments, the controller of the faucet is touchless and configured to receive the user input as a hands-free interaction at a first distance from the controller when the capacitive field strength setting is adjusted to the medium setting.

In some embodiments, the controller of the faucet is touchless and configured to receive the user input as the hands-free interaction at a second distance from the controller when the capacitive field strength setting is adjusted to the high setting, wherein the second distance is larger than the first distance.

In some embodiments, the lock of the faucet is a dial adjustable between the unlocked position and a locked position.

In some embodiments, the faucet comprises one or more illuminators disposed on at least the first portion of the faucet body.

In some embodiments, the one or more illuminators of the faucet are configured to illuminate a first color when the lock is in the unlocked position and a second color when the lock is in a locked position.

In some embodiments, the faucet body is fluidly connected to an ozone generator configured to add ozone gas to a cold water supply to generate the active oxygen water supply.

In some embodiments, the faucet comprises one or more processors configured to cause the ozone generator to be activated to generate the active oxygen water supply when the one or more processors receive a signal indicating the user input and the lock is in the unlocked position.

In some embodiments, the faucet body comprises a removably docked spray head comprising the water outlet.

In some embodiments, the active oxygen water supply is dispensed from the water outlet of the spray head in a shower spray mode.

In some embodiments, the faucet comprises a handle disposed on a second portion of the faucet body, wherein the second portion is opposite from the first portion, and the handle is configured to cause a mixing valve of the one or more valves to be actuated to an open position to allow the faucet body to dispense a tap water supply from the water outlet.

In some embodiments, the faucet comprises an ozone generator configured to be deactivated when the handle is engaged to allow the faucet body to dispense the tap water supply from the water outlet.

In some embodiments, the controller of the faucet is cylindrical and disposed on the first portion of the faucet body such that a circular face of the cylindrical controller is perpendicular to the faucet body.

In some embodiments, a side sprayer for dispensing active oxygen water is provided, the side sprayer comprising: a side spray docking station and a spray head, wherein the spray head comprises a water outlet, and the side spray docking station comprises: a controller disposed on a first portion of the side spray docking station and configured to detect a user input requesting active oxygen water to be dispensed from the spray head; and a lock disposed on a second portion of the side spray docking station; and one or more valves fluidly connected to the spray head and configured to allow an active oxygen water supply to be dispensed, wherein, when the lock is in an unlocked position and the controller detects the user input, the one or more valves is actuated to an open position to allow the spray head to dispense the active oxygen water supply from the water outlet.

In some embodiments, the side sprayer comprises one or more processors communicatively coupled to the controller and configured to cause the one or more valves to be actuated to the open position when the one or more processors receive a signal indicating the user input and the lock is in the unlocked position.

In some embodiments, the one or more valves of the side sprayer are actuated to a closed position when the controller detects a second user input requesting active oxygen water to stop being dispensed.

In some embodiments, the side sprayer comprises one or more processors configured to cause the one or more valves to be actuated to the closed position when the one or more processors receive a signal indicating the second user input.

In some embodiments, the controller of the side sprayer comprises one or more capacitive sensors.

In some embodiments, the side sprayer comprises one or more receivers configured to receive a control signal comprising an instruction to adjust a capacitive field strength setting of a capacitive field generated at least in part by the one or more capacitive sensors.

In some embodiments, the capacitive field is adjustable between a high, medium, and low capacitive field strength setting.

In some embodiments, the controller of the side sprayer is touch-sensitive and configured to receive the user input at least when the capacitive field strength setting is adjusted to the low setting.

In some embodiments, the controller of the side sprayer is touchless and configured to receive the user input as a hands-free interaction at a first distance from the controller when the capacitive field strength setting is adjusted to the medium setting.

In some embodiments, the controller of the side sprayer is touchless and configured to receive the user input as the hands-free interaction at a second distance from the controller when the capacitive field strength setting is adjusted to the high setting, wherein the second distance is larger than the first distance.

In some embodiments, the lock of the side sprayer is a switch adjustable between the unlocked position and a locked position.

In some embodiments, the side sprayer comprises one or more illuminators disposed on at least a portion of the spray head.

In some embodiments, the one or more illuminators of the side sprayer are configured to illuminate a first color when the lock is in the unlocked position and a second color when the lock is in a locked position.

In some embodiments, the spray head of the side sprayer is fluidly connected to an ozone generator configured to add ozone gas to a cold water supply to generate the active oxygen water supply.

In some embodiments, the side sprayer comprises one or more processors configured to cause the ozone generator to be activated to generate the active oxygen water supply when the one or more processors receive a signal indicating the user input and the lock is in the unlocked position.

In some embodiments, the spray head is removably docked on the side spray docking station.

In some embodiments, the active oxygen water supply is dispensed from the water outlet of the spray head in a shower spray mode.

In some embodiments, the side sprayer comprises a touch-sensitive controller disposed on a portion of the spray head opposite the water outlet and configured to detect the user input requesting active oxygen water to be dispensed from the spray head.

In some embodiments, the side sprayer comprises one or more processors communicatively coupled to the touch-sensitive controller and configured to cause the one or more valves to be actuated to the open position when the one or more processors receive a signal indicating the user input and the lock is in the unlocked position.

In some embodiments, any one or more of the features, characteristics, or elements discussed above with respect to any of the embodiments may be incorporated into any of the other embodiments mentioned above or described elsewhere herein.

### BRIEF DESCRIPTION OF THE FIGURES

FIGS. 1A-1B show perspective views of a kitchen sink faucet for dispensing active oxygen water, according to some embodiments.

FIGS. 1C-1E show various views of a spray head of a kitchen sink faucet for dispensing active oxygen water, according to some embodiments.

FIGS. 2A-2B show perspective views of a side sprayer for dispensing active oxygen water, according to some embodiments.

FIGS. 2C-2D show various views of a spray head of a side sprayer for dispensing active oxygen water, according to some embodiments.

FIGS. 3A-3B show perspective views of a side sprayer for dispensing active oxygen water, according to some embodiments.

FIGS. 3C-3D show various views of a spray head of a side sprayer for dispensing active oxygen water, according to some embodiments.

FIG. 4 illustrates a system for controlling a kitchen sink fluid dispenser for dispensing active oxygen water, according to some embodiments.

### DETAILED DESCRIPTION

Described herein are active oxygen water dispensers embodied in kitchen faucets and/or side sprayers adjacent to a kitchen sink.

As described above, conventional kitchen faucets and/or side sprayers only dispense tap water from a well water and/or municipal water supply. However, without a cleansing agent, tap water is generally inadequate for use in sanitizing dirty/used kitchen utensils, surfaces, users' hands, etc. Additionally, tap water is often inadequate in properly cleaning fresh produce prior to user consumption. Accordingly, the faucets and side sprayers disclosed herein may dispense active oxygen water for sanitizing surfaces, produce, kitchen tools, the kitchen sink, cleaning supplies (e.g., sponges, dish rags, etc.), and users' hands. Active oxygen water may also sanitize internal waterways of the faucet and/or the side sprayer each time the active oxygen water supply is activated and dispensed.

In some embodiments, the disclosed active oxygen water dispensers may include a controller comprising one or more capacitive sensors, handle, and/or one or more touch-sensitive features (e.g., buttons, switches, capacitive touch sensors, pressure sensors, etc.) for controlling the dispenser hands-free and/or manually, based on a user's preference. In some embodiments, the active oxygen water dispenser may include a lock, such that while in an unlocked setting, active oxygen water can be dispensed; and in a locked setting, the active oxygen water dispenser can only dispense tap water. The active oxygen water dispenser may comprise one or more illuminators (e.g., light indicators) for communicating the type of water being dispensed during use of the faucet and/or side sprayer.

In some embodiments, the active oxygen water dispenser may additionally include one or more operating settings for the controlling the strength of the capacitive field generated by one or more capacitive sensors, such that a user may customize if and/or how they engage with the controller to control when active oxygen water is dispensed. For example, a user may choose to physically engage with the controller (e.g., push/tap a button, capacitive touch sensor, pressure sensor, etc.) to allow and disallow dispensing of active oxygen water. In some embodiments, the user may select a capacitive field strength setting (e.g., low, medium, high, etc.) such that the user can interact with the controller hands-free at different distances from the device.

In some embodiments, the active oxygen water dispenser is embodied in a kitchen faucet, such that the faucet may dispense either the tap water supply or an active oxygen water supply at a given time based on a user input. In some embodiments, the active oxygen water dispenser is embodied in a side sprayer disposed adjacent to a kitchen faucet and configured to dispense active oxygen water towards a kitchen sink. In some embodiments, the side sprayer can dispense either active oxygen water or a tap water supply based on a user input. The kitchen faucet and/or side sprayer may comprise a removably docked spray head such that a user may hold the spray head of the faucet/side sprayer and manipulate the spray head in a plurality of directions/orientations to direct the water supply towards an area of interest in the kitchen sink. In some embodiments, the spray head may dispense the active oxygen water supply in a shower spray and/or single stream mode.

Referring now to the drawings, like parts are marked throughout the specification and drawings with the same reference numerals, respectively.

### Kitchen Faucet for Dispensing Active Oxygen Water

In some embodiments, a faucet, such as that which is installed for use in a kitchen, may have the ability to alternate between dispensing tap water from a municipal water supply and/or well water supply and an active oxygen water supply, for example, based on a user input and/or engagement with a handle of the faucet.

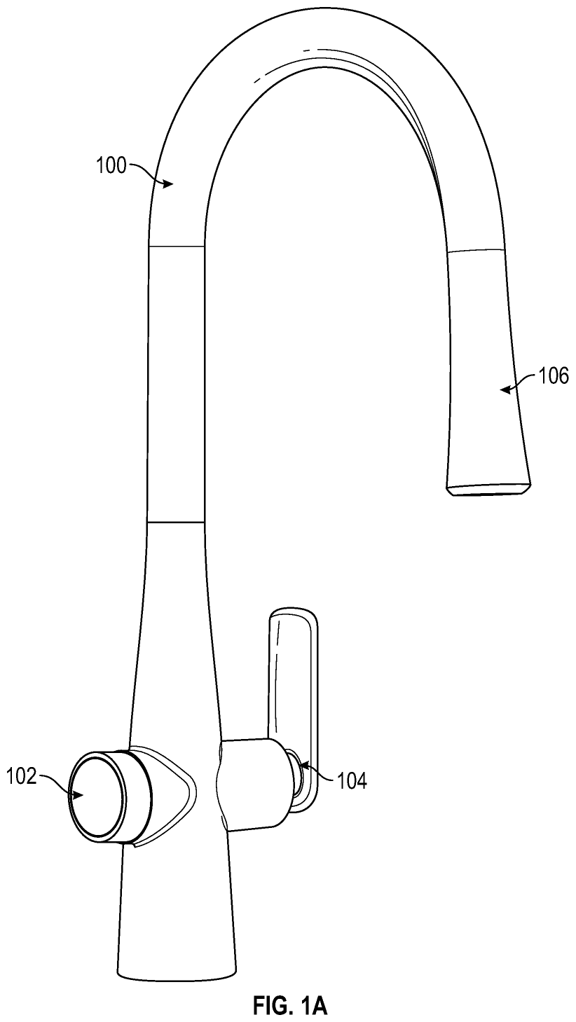

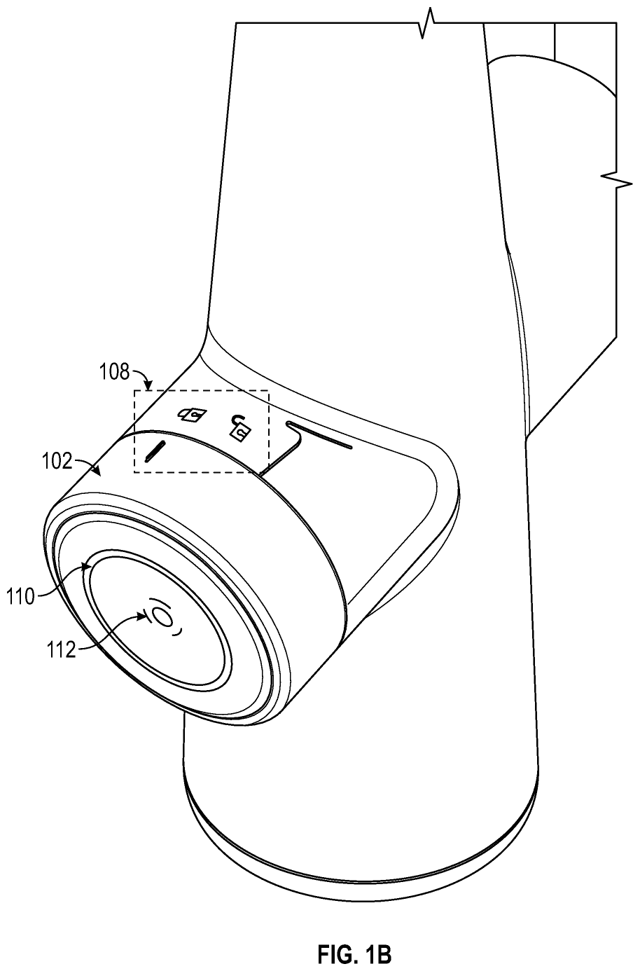

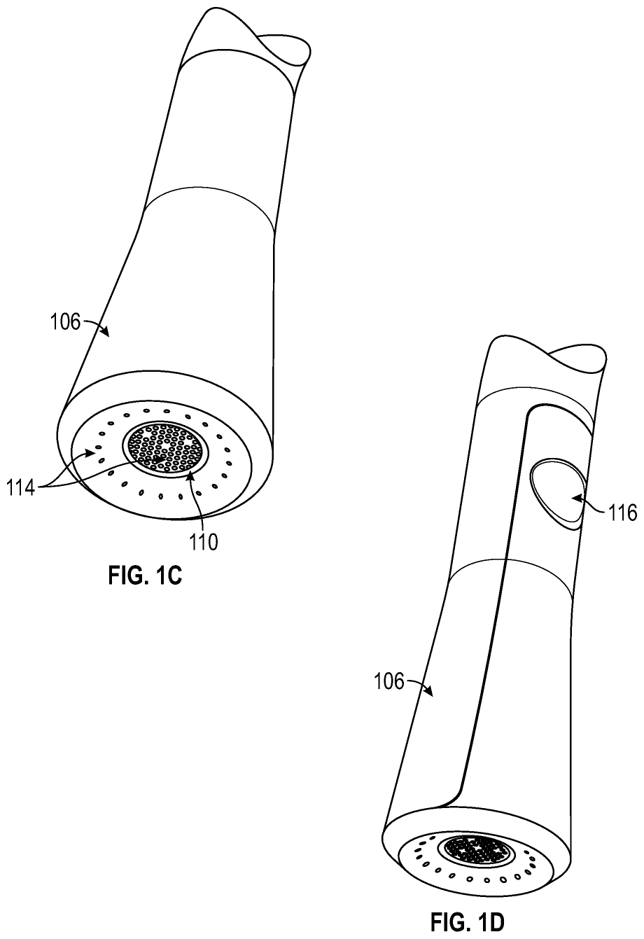

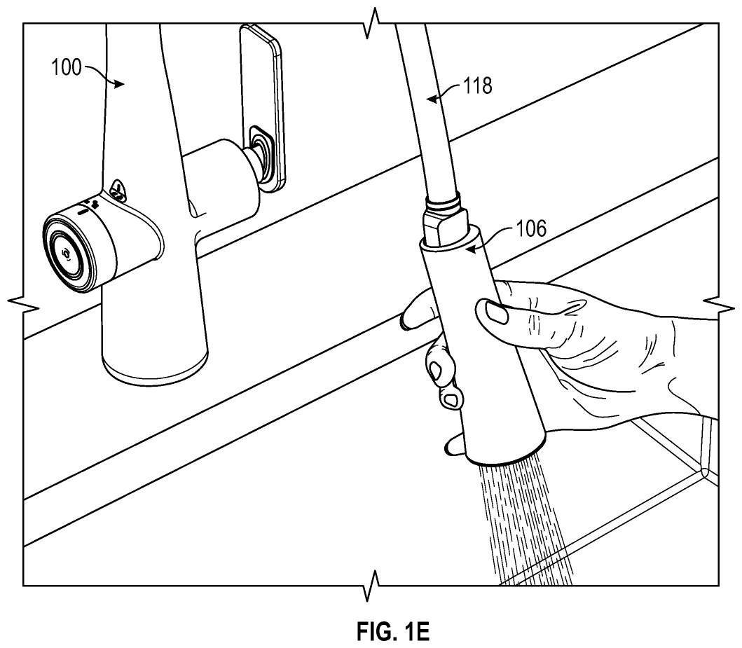

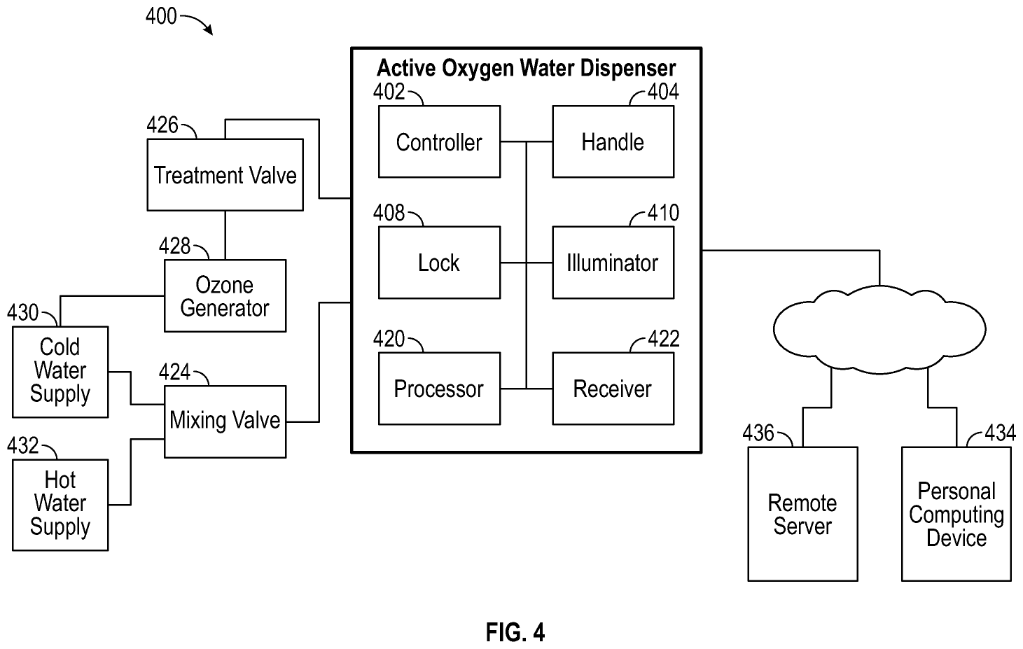

FIG. 1A shows a perspective view of a faucet body 100, and FIGS. 1B-1E show additional views of various components of faucet body 100. As shown, faucet body 100 may comprise a controller 102, a handle 104, and a spray head 106. Faucet body 100 may be mounted on a kitchen surface such that water is dispensed from faucet body 100 toward a kitchen sink. Faucet body 100 may be fluidly connected to a hot water supply, cold water supply, and a treatment assembly, as will be discussed in greater detail below with regards to FIG. 4.

Faucet body 100 may be any type of kitchen faucet; for example, faucet body 100 may comprise a spout housing a hose (e.g., a single or multi-channel hose) fluidly connected between a water supply below a kitchen surface (i.e., below-deck) and a water outlet (e.g., disposed on spray head 106). The spout may be rotatable, for example, at a position along a vertical portion of the spout, such that a stream of water from a water outlet may be directed to a plurality of areas within a kitchen sink. The hose within the spout may have slack, such that a user may pull spray head 106 down and/or out. In some embodiments, the spout of faucet body 100 may comprise a flexible hose surrounded by one or more springs of a pre-determined stiffness for dispensing water from a water outlet of faucet body 100 to an area in a kitchen sink. The flexible hose may be removably docked, for example, to a stationary arm component attached to the faucet body (not illustrated).

Faucet body 100 may comprise a water outlet oriented by default toward a kitchen sink area. In some embodiments, spray head 106 of faucet body 100 may comprise the water outlet. Spray head 106 may be fluidly connected to a water supply (e.g., hot water supply, cold water supply, active oxygen water supply, etc.) for dispensing water. Spray head 106 may be removably docked such that a user may hold spray head 106 and manipulate the direction of a stream of water exiting spray head 106 toward a kitchen sink. Spray head 106 will be described in greater detail below with regards to FIGS. 1C-1E.

An example faucet system configured to deliver enhanced water (e.g., ozone-infused water) with a water treatment assembly is described in greater detail in PCT/US2022/015898, the contents of which are incorporated by reference herein in their entirety. For example, the water treatment assembly may comprise an ozone generator configured to generate ozone gas, a treatment valve, and a treatment valve actuator. In some embodiments, the treatment valve may comprise a solenoid valve electrically connected to a power source (e.g., one or more batteries, wired plugs, etc.). The below-deck configuration for providing a water supply to be delivered at the water outlet of faucet body 100 may comprise a first valve for dispensing tap water (e.g., from a hot water supply, cold water supply, and/or a mixture of hot and cold water supply), and a second valve for dispensing active oxygen water. In some embodiments, the second valve is in fluid communication with the ozone generator and a cold water supply, such that ozone gas may only be distributed in combination with cool water at least because hot water may cause degradation of the ozone gas. In instances where the household water supply is from a well water supply, the cold water supply in fluid communication with the ozone generator may require filtration prior to ozonation.

In some embodiments, faucet body 100 may comprise at least one handle 104. In some embodiments, handle 104 may be configured to actuate one or more valves fluidly connected to faucet body 100 to dispense a water supply from the water outlet of faucet body 100. For example, handle 104 may dispense tap water from a cold water supply, hot water supply, and/or a mixture of hot and cold water by actuating a mechanical valve (e.g., valve cartridge). In some embodiments, handle 104 may comprise a knob, lever, tangible button, capacitive touch sensor, pressure sensor, etc. with which a user may engage to control the flow of water. Handle 104 may be rotatable about a first axis (e.g., at least up to 2700), such that rotating handle 104 in a first direction about the first axis causes warm water to be dispensed from the water outlet, and rotating handle 104 in a second direction about the first axis causes cool water to be dispensed from the water outlet. In some embodiments, faucet body 100 may be rotatable about a second axis (e.g., at least up to 180°), such that rotating handle 104 in a first direction about the second axis activates the water supply and/or increases the volume water dispensed, and rotating handle 104 in a second direction about the second axis deactivates the water supply and/or decreases the volume of water dispensed.

Handle 104 may be located along any portion of faucet body 100. In some embodiments, handle 104 may be positioned on the base (e.g., lower portion) of faucet body 100. Handle 104 may be positioned laterally to the faucet body 100 (e.g., perpendicular to the concentric axis of faucet body 100), as shown in FIG. 1A. In some embodiments, faucet body 100 may comprise more than one handle 104 (not illustrated). For example, faucet body 100 may comprise a first handle 104 for dispensing warm water, and a second handle 104 for dispensing cool water. Each of the first and second handle 104 may be rotated about an axis (e.g., second axis described above) to activate and deactivate the water supply and/or modify the volume of water dispensed from a water outlet of faucet body 100.

Faucet body 100 may comprise a controller 102 for controlling the delivery of active oxygen water. Controller 102 may be configured to operate in a hands-free and/or touch-sensitive mode. For example, in a hands-free mode, the controller 102 may comprise one or more capacitive sensors such that the device may detect a user input in the form of an object (e.g., human hand, kitchen tool, etc.) in the capacitive field generated at least in part by the one or more capacitive sensors and surrounding the controller. The received user input may cause at least one signal to be transmitted to one or more processors communicatively coupled to faucet body 100 (illustrated in FIG. 4). The processor(s) may receive the at least one signal and cause a water treatment assembly (e.g., a treatment valve actuator, one or more treatment valves, an ozone generator, etc.) to be activated to dispense active oxygen water. In some embodiments, controller 102 may communicate a signal to one or more components of the water treatment assembly via one or more wired electrical switches instead of or in addition to the processor.

In some embodiments, controller 102 may be configured to operate in a touch-sensitive mode in addition to or instead of a hands-free mode. Thus, controller 102 may comprise one or more touch-sensitive features, for example, a button, capacitive touch sensor, pressure sensor, switch, handle (e.g., lever, knob, etc.) configured to control the delivery of active oxygen water. For example, a user may tap and/or push a button, switch, or sensor of controller 102 to actuate and/or unactuate one or more treatment valves in addition to or instead of engaging with controller 102 in a hands-free mode. Touch-sensitive features of controller 102 will be described in greater detail with relation to FIG. 1B.

As shown in FIG. 1A, controller 102 may have a circular profile and extend laterally (e.g., in a direction perpendicular to the concentric axis of faucet body 100) from a base of faucet body 100. In some embodiments, controller 102 may comprise a profile of any shape; for example, an oval/ellipse, triangle, rectangle, square, or polygon with five or more sides. In some embodiments, the controller 102 may extend less than or equal to 2, 3, 4, 5, 6, 7, or 8 cm laterally from faucet body 100. In some embodiments, the controller 102 may extend greater than or equal to 2, 3, 4, 5, 6, 7, or 8 cm laterally from faucet body 100. In some embodiments, controller 102 may be embedded in faucet body 100, such that each of the interactive features of controller 102 described above are located within faucet body 100 and an additional portion/body is not required to extend from faucet body 100.

The controller 102 may extend laterally in any direction from faucet body 100. For example, the controller 102 may be located on faucet body 100 such that the device “mirrors” handle 104 (e.g., handle 104 extends in one direction laterally from faucet body 100, and controller 102 extends in a second direction laterally from faucet body 100, wherein the two directions are opposite of one another, shown in FIG. 1A). In some embodiments, controller 102 may be positioned on a same side of faucet body 100 as handle 104. For example, controller 102 may be positioned above or below handle 104. In some embodiments, one or more features of controller 102 may be incorporated into handle 104, such that handle 104 is configured to control dispensing of the active oxygen water supply and tap water supply. In some embodiments, controller 102 may extend from a backside of faucet body 100 (e.g., away from the kitchen sink).

In some embodiments, controller 102 may be located less than or equal to 4, 6, 8, 10, 12, 14, or 16 cm from a surface (e.g., kitchen surface illustrated in FIG. 1E). In some embodiments, controller 102 may be located greater than or equal to 4, 6, 8, 10, 12, 14, or 16 cm from a surface. The controller 102 may be sized ergonomically such that a user may engage with one or more interactive features on and/or within controller 102 with ease, yet the device does not obstruct a large area surrounding the faucet body 100. In some embodiments, controller 102 may comprise at least one surface (or face) on which one or more buttons, capacitive touch sensors, pressure sensors, switches, etc. may be disposed. In some embodiments, the face may be oriented outwards in a direction opposite of faucet body 100. In some embodiments, the face may be flat, rounded (e.g., partially spherical), etc. The face may be less than or equal to 2, 4, 6, or 8 cm in diameter. In some embodiments, the face of controller 102 may be greater than or equal to 2, 4, 6, or 8 cm in diameter. In some embodiments, controller 102 may comprise a material different from that of the faucet body 100. For example, faucet body 100 may comprise stainless steel and/or zinc, wherein controller 102 may comprise a metal or a polymer. For example, interactive features on faucet body 100 (e.g., one or more buttons, switches, etc.) may comprise an engineering thermoplastic and/or elastomer (e.g., polyamide, polyester, polycarbonate, acrylonitrile-butadiene-styrene (ABS), polyacetal, silicone, etc.). In some embodiments, thermoplastics and elastomers may have adhered thereto and/or incorporated therein one or more antimicrobial additives (e.g., silver compounds, zinc compounds, copper compounds, etc.).

In some embodiments, by activating an active oxygen water supply via controller 102, the tap water supply actively being delivered (e.g., from engagement with handle 104) may be discontinued, and vice versa. In some embodiments, the two different types of water streams may be dispensed in a different manner; for example, a tap water supply may be dispensed in a single stream from a water outlet, and an active oxygen water supply may be dispensed in a shower stream from the water outlet. In some embodiments, active oxygen water may be delivered in a first waterway in fluid communication with a treatment valve (and treatment assembly, described above), and tap water may be delivered in a second waterway in fluid communication with a valve for tap water. In some embodiments, a single valve may control the delivery of water (e.g., regardless of water type), and/or a single waterway may deliver both types of water. For example, controller 102 may actuate the valve, as well as an ozone generator, whereas handle 104 may only actuate the valve. In some embodiments, the active oxygen water supply may not be delivered unless the lock is set to an “unlocked” position, as will be described in greater detail with respect to FIG. 1B.

FIG. 1B shows a perspective view of faucet body 100 comprising controller 102. As mentioned above, controller 102 may be configured to operate in a touch-sensitive and/or hands-free mode. In some embodiments, in addition to or in place of controller 102, faucet body 100 may comprise a touch-sensitive controller 112. In some embodiments, the touch-sensitive controller 112 may be disposed in substantially the same portion of faucet body 100 as controller 102. In some embodiments, as described above, touch-sensitive controller 112 may be embodied within controller 102. In some embodiments, touch-sensitive controller 102 may be disposed on a different portion of faucet body 100 distinct from controller 102. For example, touch-sensitive controller may be located proximate to and/or within handle 104, on a back-side of faucet body 100, or on a front-side of faucet body 100.

Touch-sensitive controller 112 may comprise one or more of a button, switch, handle, capacitive touch sensor, pressure sensor, etc. The touch-sensitive controller 112 may be configured to, like controller 102, cause active oxygen water to dispense from a water outlet of faucet body 100. The profile of the touch-sensitive controller 112 may comprise a circle, oval, triangle, square, rectangle, or other polygon shape. In some embodiments, touch-sensitive controller 112 may protrude from faucet body 100. In embodiments where controller 102 and touch-sensitive controller 112 are disposed in substantially the same portion of faucet body 100, touch-sensitive controller may protrude from a face of controller 102 (e.g., concaved outward from a plane along the face of controller 102). In some embodiments, touch-sensitive controller 112 may be recessed from the face of controller 102 (e.g., concaved inward from a plane along the face of controller 102). In some embodiments, touch-sensitive controller 112 may be accentuated via one or more illuminators 110 (e.g., light indicators), a printed icon, etc. In some embodiments, touch-sensitive controller 112 may be indicated by a combination of the above-described features. For example, as shown in FIG. 1B, a touch-sensitive controller 112 may be circular in shape and include one or more text features, an icon, and may be accentuated with a ring-shaped illuminator 110.

A user may engage with touch-sensitive controller 112, for example, by pushing/tapping and releasing after a short period of time (e.g., 1, 2, 3 seconds or less) to activate the active oxygen water supply. In some embodiments, by pushing/tapping and releasing the touch-sensitive controller 112 a second time, the user may deactivate (or turn off) the active oxygen water supply.

In some embodiments, an illuminator 110 on faucet body 100 may be configured as a ring-shape encircling touch-sensitive controller 112, as described above. In some embodiments, illuminator 110 may be configured proximate to, but not surrounding touch-sensitive controller 112 and/or controller 102. In some embodiments, illuminator 110 may additionally or instead be disposed on a different portion of faucet body 100. In some embodiments, illuminator 110 may comprise one or more light emitting diodes (LEDs). In some embodiments, illuminator 110 may be configured to light a first color indicating that an active oxygen water supply is currently being dispensed and/or may be dispensed upon engagement with controller 102. In some embodiments, illuminator 110 may be configured to light a second color indicating that tap water is currently being dispensed and/or active oxygen water may not be dispensed upon engagement with controller 102 (e.g., the lock 108 as described in greater detail below is positioned on a locked setting). Illuminator 110 may be configured to illuminate in a plurality of colors (e.g., red, green, blue, white, etc.). In some embodiments, illuminator 110 may flash for a pre-determined duration of time (e.g., 2, 3, 4, 5 seconds) and/or remain solid-colored, wherein a presence of flashing may indicate the water type being dispensed, lock status, etc.

In some embodiments, as described in greater detail in PCT/US2022/015898 (incorporated herein by reference), illuminator 110 may additionally or instead indicate one or more of a status of a water treatment assembly (e.g., whether the water treatment assembly is ready to deliver active oxygen water), type of water being delivered (e.g., active oxygen water or tap water), and/or a battery status of one or more components of the system. For example, a user may experience a delay in time between activating an active oxygen water supply via controller 102 and a time at which the active oxygen water is ready to use; and illuminator 110 may indicate this change in status. In some embodiments, illuminator 110 may indicate the status (or life) of a battery and/or ozone generator. For example, a color of illuminator 110, whether illuminator 110 is flashing and/or solid-colored, etc. may indicate to a user the expected life remaining for the ozone generator and/or one or more batteries configured to provide power to one or more components of the system.

Faucet body 100 may additionally comprise a lock (e.g., locking mechanism) 108, illustrated in FIG. 1B as located proximate to controller 102 (e.g., located on the same portion of faucet body 100). In some embodiments, the lock 108 may instead be embodied in handle 104, along a portion of the base of faucet body 100 (e.g., on a back side of the faucet body base), or in another area of faucet body 100 distinct from controller 102. The lock 108 may comprise a dial, switch, button, capacitive touch sensor, pressure sensor, etc. with which a user may engage to alternate between a locked and unlocked setting. In some embodiments, the lock 108 may be configured to activate an ozone generator and/or actuate one or more valves in combination with the controller 102, such that when lock 108 is in an unlocked setting, an active oxygen water supply may be delivered via a water outlet (e.g., upon receipt of a signal from controller 102), and when the lock 108 is in a locked setting, only tap water supply may be delivered (e.g., regardless of a signal from controller 102). For example, lock 108 may be configured to block a signal from a controller 102 to one or more processors, the signal indicative of a request to activate the active oxygen water supply, in the instance lock 108 is set to the locked setting.

In some embodiments, such as illustrated in FIG. 1B, lock 108 may be a circular dial embodied in a portion of faucet body 100 that is shared with controller 102. For example, a user may rotate the dial in a first direction along a concentric axis of controller 102 to position the lock 108 in a locked setting, and the user may rotate the dial in a second direction along the concentric axis to position the lock 108 in an unlocked setting. In some embodiments, in adjusting the lock 108 between an unlocked and locked setting, the user may receive tactile feedback from the lock, such that the lock “clicks” into place in each of the settings. In embodiments where the lock 108 is a dial, the dial may have limited rotation abilities; for example, the dial may not be rotatable 360° and rather may be rotated between the two pre-defined settings. For example, the dial may be rotated greater than or equal to a 5°, 10°, 15°, 20°, 25°, or 30° between a locked and unlocked setting. In some embodiments, the dial may be rotated less than or equal to a 5°, 10°, 15°, 20°, 25°, or 30° between a locked and unlocked setting.

In some embodiments, each of the unlocked and locked settings may be denoted by one or more symbols, icons, letters, words, etc. on faucet body 100. For example, FIG. 1B illustrates a lock symbol and an unlock symbol corresponding to each of the positions. In some embodiments, the lock 108 may include an indicator (e.g., an illuminator, a colored marker, etc.) for indicating to the user what setting the lock is on. For example, the indicator may align with either the lock symbol or the unlock symbol based on the position configured by the user. In embodiments where the indicator of lock 108 is an illuminator, the color of the illuminator may correspond with that of illuminator 110 described in greater detail above. For example, in the instance lock 108 is set to the locked setting, each of the illuminator 110 and/or the illuminator of the lock 108 may illuminate the same color (e.g., red, white, blue, green, etc.).

In some embodiments, controller 102 may comprise a touchless (e.g., hands-free) mode such that a user may activate and/or deactivate the delivery of active oxygen water without physically engaging with controller 102. In some embodiments, the touchless mode may be provided at least in part from a capacitive field surrounding controller 102. For example, controller 102 may comprise one or more sensor plates (e.g., capacitive sensors) proximate to a conductive area and capable of generating a capacitive field in the presence of a grounded, conductive object (e.g., hand, kitchen tool, etc.) when charged (e.g., via a power supply). In some embodiments, controller 102 may comprise one or more driven shield electrodes (e.g., shield drivers) for focusing the sensor(s) output and directing the output in a desired direction. Upon detecting a user input in the capacitive field, controller 102 may send a signal to one or more processors to activate or deactivate the active oxygen water supply, as will be described in greater detail with respect to FIG. 4.

In some embodiments, the capacitive field strength of controller 102 may be customizable by a user such that a user may select one or more preferences for the strength of the capacitive field. For example, a user may select between a low, medium, or high setting corresponding with distinct capacitive field values/ranges. In some embodiments, the user may select between greater than three settings, for example, 4, 5, 6, or more settings. In some embodiments, each of the capacitive field strength settings may correspond with a maximum distance from controller 102 that the field may detect a user input within. For example, the capacitive field may be configured to detect a “touchless” input from a minimum distance of 0.1 mm away from controller 102. In some embodiments, the capacitive field may be configured to detect a “touchless” input up to at least 50 mm from controller 102. A user may select a capacitive field strength using, for example, a personal computing device (e.g., desktop, mobile device, etc.), remote controller, control pad, button, dial, etc. which may be configured to send one or more signals to the components generating the capacitive field (e.g., via wired and/or wireless communication), and the capacitive field may update accordingly. For example, based on the one or more signals, the charge provided to the sensor(s) and/or shield driver(s) may be increased and/or decreased to create a larger and/or smaller magnitude capacitive field.

In some embodiments, a user may choose not to use the hands-free mode of controller 102, and may deactivate (e.g., turn off) the capacitive field using one or more of a personal computing device, remote controller, control pad, switch, button, etc. Rather, the user may engage with a touch-sensitive controller 112 (optionally embodied proximate to or within controller 102) to activate and/or deactivate an active oxygen water supply.

FIGS. 1C and 1D illustrate various perspective views of spray head 106 on faucet body 100. As shown, spray head 106 may comprise one or more fluid outlets 114 (e.g., shower spray and single stream), an illuminator 110, and one or more buttons 116. Spray head 106 may comprise one or more additional materials different from faucet body 100. For example, a portion of spray head 106 comprising one or more buttons 116 may comprise a secondary material (e.g., silicone) configured to provide grip and/or tactile feedback for a user when engaging with spray head 106.

Illuminator 110 may comprise any one or more features described above with respect to illuminator 110 in FIG. 1B. For example, illuminator 110 may comprise one or more LED light arrays. In some embodiments, illuminator 110 may indicate the type of water supply being dispensed from the one or more waterways. In some embodiments, illuminator 110 may illuminate a first color when spray head 106 is dispensing active oxygen water and a second color when spray head 106 is dispensing tap water. In some embodiments, illuminator 110 may be activated for a short period of time (e.g., 2, 3, 4, 5 or more seconds) to indicate the type of water being dispensed. In some embodiments, indicator 110 may remain active for the duration of a water supply being dispensed. In some embodiments, illuminator 110 may flash, for example, when active oxygen water is being dispensed.

In some embodiments, button 116 may be configured to activate and/or deactivate an active oxygen water supply similar to as described above with regards to touch-sensitive controller 112 in FIG. 1B. In some embodiments, button 116 may instead or additionally be configured to cause faucet body 100 to alternate between delivering a tap water supply and an active oxygen water supply. In some embodiments, a user may engage with button 116 for a variable length of time (e.g., 2, 3, 4, 5 or more seconds at a time) to cause faucet body 100 to alternate between one or more settings. For example, settings may include (1) dispensing tap water, (2) dispensing active oxygen water, and (3) not dispensing water (e.g., tap water or active oxygen water). Additional settings may include the type of water stream delivered through spray head 106. For example, button 116 may be configured to alternate between dispensing tap water through shower spray and single stream water outlets 114. Likewise, button 116 may additionally or instead be configured to alternate between dispensing active oxygen water through shower spray and single stream water outlets 114. In some embodiments, spray head 106 may deliver an active oxygen water supply or tap water supply simultaneously through shower spray and single stream water outlets 114 (e.g., an active oxygen water supply is delivered through both water outlets at the same time).

In some embodiments, spray head 106 may be configured to deliver an active oxygen water supply in a shower spray mode, and tap water in a single stream mode. For example, a designated active oxygen water supply water way may be fluidly connected with a shower spray water outlet, whereas a designated tap water supply waterway may be fluidly connected with single stream water outlet (e.g., faucet body 100 and spray head 106 comprise multiple water ways). In some embodiments, one or more of faucet body 100 and/or spray head 106 may comprise a single water way, such that the water type delivered through the water outlet 114 is alternated below-deck between the one or more valves in fluid connection with the waterway.

FIG. 1E illustrates a perspective view of a user engaging with spray head 106 of faucet body 100. As mentioned above, spray head 106 may be removably docked to a portion of faucet body 100 (illustrated in FIG. 1A). A user may remove spray head 106 from the docked position to direct the water outlet of spray head 106 to a plurality of areas in a kitchen sink. In some embodiments, at least a portion of a hose 118 may be disposed within a spout of faucet body 100 and have slack, such that a user may pull spray head 106 (fluidly connected to hose 118) out and/or down and manipulate the flow of water delivered from spray head 106. In some embodiments, upon releasing spray head 106, hose 118 may be configured to retract into the spout of faucet body 100 to return spray head 106 to a docked position.

### Side Sprayer for Dispensing Active Oxygen Water

In some embodiments, a side sprayer (e.g., side spray device), such as that which is installed adjacent to a standard kitchen faucet, may dispense active oxygen water, wherein the adjacent faucet may be configured to dispense a standard tap water supply.

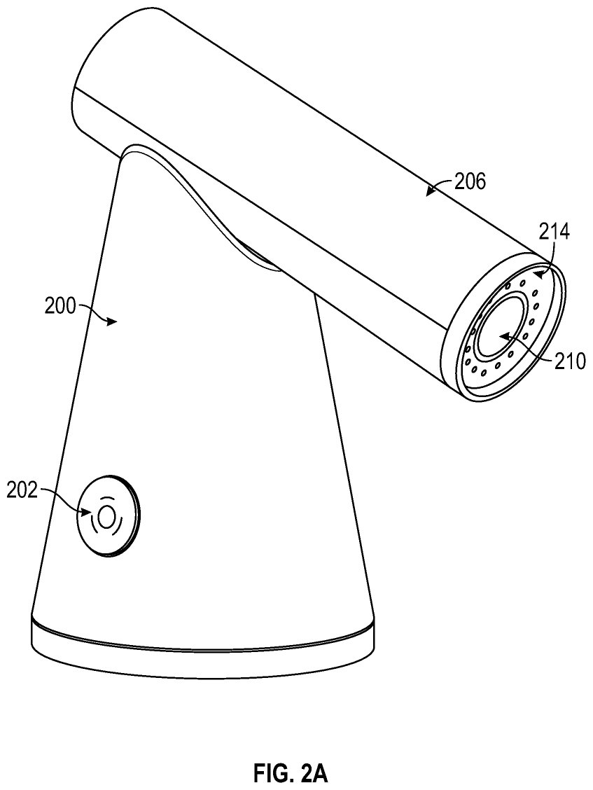

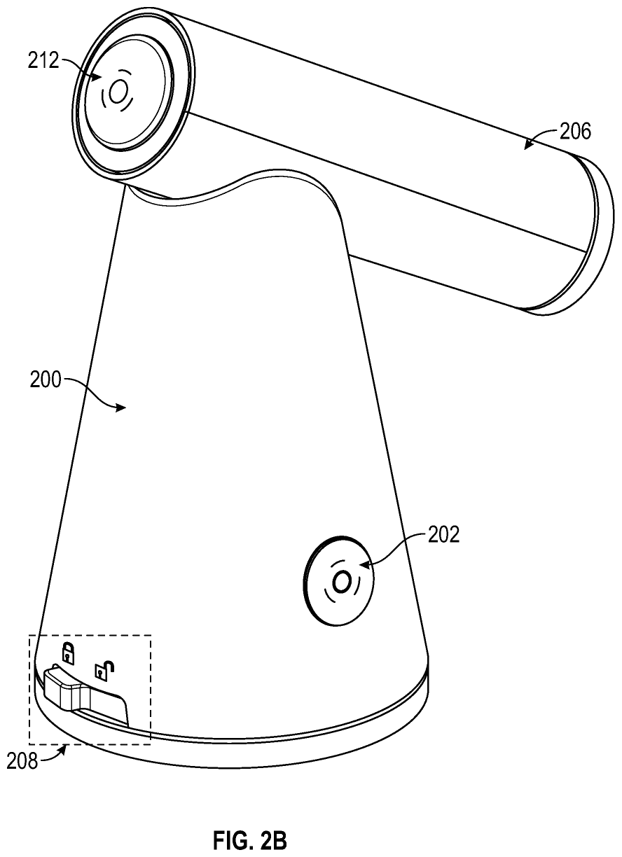

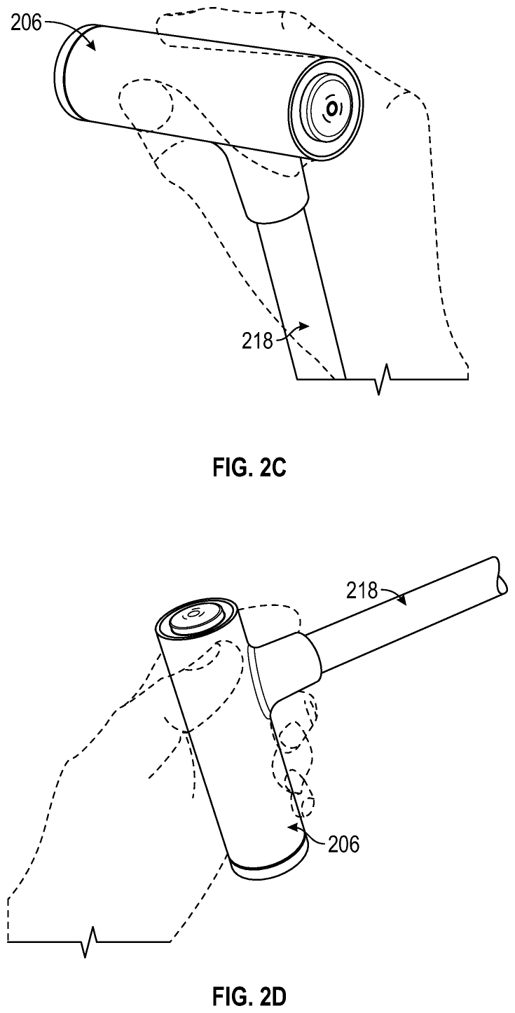

FIGS. 2A-2B show perspective views of a side sprayer 200 for dispensing active oxygen water. In some embodiments, side sprayer 200 may comprise any one or more features of faucet body 100 described above with respect to FIGS. 1A-1E. For example, side sprayer 200 may comprise a controller 202 and spray head 206. Side sprayer 200 may dispense an active oxygen water supply and/or a tap water supply (e.g., from a well water and/or municipal water supply). In some embodiments, spray head 206 may comprise a water outlet 214 that may dispense water in a wide-spray mode (e.g., shower spray) or single stream (not illustrated). In some embodiments, side sprayer 200 may comprise one or more materials, for example, stainless steel, zinc, engineering thermoplastic, and/or one or more polymers. As described above with respect to faucet body 100, interactive features on side sprayer 200 (e.g., one or more buttons, switches, etc.) may comprise an engineering thermoplastic and/or elastomer (e.g., polyamide, polyester, polycarbonate, acrylonitrile-butadiene-styrene (ABS), polyacetal, silicone, etc.). In some embodiments, thermoplastics and elastomers may have adhered thereto and/or incorporated therein one or more antimicrobial additives (e.g., silver compounds, zinc compounds, copper compounds, etc.). In some embodiments, the body of side sprayer 200 may comprise an elastomer, and one or more features or portions of side sprayer 200 may be accentuated with stainless steel, zinc, and/or engineering thermoplastic.

In some embodiments, side sprayer 200 may be installed adjacent to a faucet (e.g., faucet body 100) of a kitchen sink. In some embodiments, side sprayer 200 may be configured to be installed in place of an existing fixture adjacent to a kitchen sink (e.g., soap dispenser, pre-existing side sprayer dispensing only tap water, etc.).

Controller 202 may be configured to operate in a similar fashion as controller 102 of faucet body 100 described above with respect to FIGS. 1A-1E. For example, controller 202 may comprise one or more capacitive sensors configured to generate a capacitive field for hands-free control of side sprayer 200. In some embodiments, controller 202 may comprise a touch-sensitive portion (e.g., button, capacitive touch sensor, pressure sensor, switch, etc.) such that a user may additionally or instead engage with the touch-sensitive portion to activate and/or deactivate the delivery of active oxygen water. The capacitive sensors of controller 202 may be configured to operate as described above with respect to controller 102. For example, the capacitive field strength of controller 202 may be modified (e.g., via a personal computing device, remote controller, control pad, etc.) between one or more settings (e.g., low, medium, and high), such that a user may activate and deactivate the water supply from different distances from controller 202. Controller 202 may be disposed along and/or within a front, back, left, or right side of side sprayer 200. In some embodiments, controller 202 may be located proximate to the kitchen surface (e.g., on a lower end of the docking portion of side sprayer 200). For example, controller 202 may be located less than or equal to 2, 4, 6, 8, or 10 cm from the bottom of side sprayer 200. In some embodiments, controller 202 may be located greater than or equal to 2, 4, 6, 8, or 10 cm from the bottom of side sprayer 200.

As illustrated in FIG. 2A, side sprayer 200 may comprise a conical docking station (e.g., base) configured to dock spray head 206. In some embodiments, the docking station of side sprayer 200 may comprise a different shape, for example, cylindrical, rectangular, triangular, polygonal, etc. In some embodiments, spray head 206 may comprise a cylindrical shape, sized such that a user may engage (e.g., hold) spray head 206 and direct a water supply from the water outlet towards the sink. In some embodiments, spray head 206 may comprise a different shape, for example, rectangular, triangular, polygonal, etc. that allows a user to easily engage with and grip side sprayer 206 to direct water towards a kitchen sink. In some embodiments, at least a portion of spray head 206 (e.g., the lower half of spray head 206) may comprise a secondary material (e.g., silicone) configured to provide grip for a user when holding spray head 206.

In some embodiments, spray head 206 may comprise one or more illuminators 210 configured to indicate, for example, the type of water being delivered, the locking status of the device, etc. Illuminator 210 may comprise any one or more features of illuminator 110 described above with respect to FIGS. 1B-1C. In some embodiments, illuminator 210 may be disposed proximate to a water outlet 214 of spray head 206. Illuminator 210 may be ring-shaped (e.g., annular) such that it follows the pattern of water outlet 214 on spray head 206, as shown in FIG. 2A. In some embodiments, the shape of illuminator 210 may be a circle, rectangle, triangle, etc. In some embodiments, side sprayer 200 may comprise one or more illuminators 210 located along a different portion of side sprayer 200. For example, side sprayer 200 may comprise one or more illuminators 210 proximate to and/or encircling controller 202. In some embodiments, one or more illuminators 210 may be along a front side, back side, or other surface of spray head 206 and/or the docking station of side sprayer 200.

FIG. 2B illustrates one or more additional features of side sprayer 200. For example, side sprayer 200 may comprise a touch-sensitive controller 212 (e.g., on a portion of spray head 206) and a lock 208. The touch-sensitive controller 212 may comprise any one or more features of touch-sensitive controller 112 and/or button 116 on faucet body 100 described above with respect to FIG. 1B and FIG. 1D. For example, touch-sensitive controller 212 may comprise one or more buttons, switches, a pressure sensor, a capacitive touch sensor, etc. In some embodiments, touch-sensitive controller 212 may be on a back surface of spray head 206 and configured to activate and/or deactivate a water supply being delivered from the water outlet of side sprayer 200. In some embodiments, touch-sensitive controller 212 may instead be located on a side of spray head 206 (e.g., along a length of the cylindrical portion). In some embodiments, at least a portion of touch-sensitive controller 212 may be raised from a surface of side sprayer 200 such that a user may easily recognize and engage with the touch-sensitive controller 212. In some embodiments, a user may engage with touch-sensitive controller 212 by pushing/tapping the controller (e.g., for 2, 3, 4, or less seconds) to, for example, change the type of water supply being dispensed from side sprayer 200. Thus, touch-sensitive controller 212 may be configured to modify a plurality of operating conditions related to whether water is delivered from side sprayer 200 and/or the type of water being delivered. In some embodiments, a user may prefer to engage with touch-sensitive controller 212 to control the water supply when the spray head 206 is undocked from the docking station of side sprayer 200.

As illustrated in FIG. 2B, side sprayer 200 may additionally comprise lock (e.g., locking mechanism) 208. Lock 208 may comprise any one or more features of lock 108 described above with respect to FIG. 1B. For example, lock 208 may be configured to allow and/or disallow active oxygen water to be dispensed from side sprayer 200. In some embodiments, lock 208 may comprise a switch, dial, button, pressure sensor, capacitive touch sensor, etc. For example, as shown in FIG. 2B, lock 208 may be a switch configured to alternate between a locked position and an unlocked position. In some embodiments, lock 208 may provide tactile feedback (i.e., “click”) at each of the locking positions. In some embodiments, lock 208 may be accentuated, for example, using a different color (e.g., red, blue, silver, etc.) from the remainder of the body of side sprayer 200. In some embodiments, a portion of lock 208 may be raised from a surface of side sprayer 200 such that a user may easily locate and engage with lock 208. In some embodiments, lock 208 may be located along a lower portion of the docking station of side sprayer 200. For example, lock 208 may be located along a front, side, or back portion of the docking station of side sprayer 200. In some embodiments, lock 208 is located along a different portion/surface of side sprayer 200.

In some embodiments, lock 208 may be communicatively coupled with illuminator 210 (e.g., illustrated in FIG. 2A). For example, a user may manipulate a locking setting of lock 208, and illuminator 210 may be configured to indicate a locking setting of the lock 208. For example, illuminator 210 may illuminate a first color (e.g., red, green, blue, white, etc.) when active oxygen water cannot be dispensed and/or lock 208 is on a locked setting, and a second color when active oxygen water can be dispensed and/or lock 208 is on an unlocked setting. In some embodiments, illuminator 210 may flash (e.g., for pre-defined duration of time) to indicate when a locking position of the lock 208 has been modified.

FIGS. 2C-2D show various views of a user engaging with spray head 206 of side sprayer 200. In some embodiments, spray head 206 may be configured to be operably removed from the docking station (e.g., base) of side spray 200 such that a user may direct a stream of water from the water outlet of spray head 206 in a plurality of directions towards the kitchen sink. Spray head 206 may be fluidly connected to a hose 218, such that hose 218 has slack and can be extended from and/or retracted to the docking station of side sprayer 200 when a user removes and replaces spray head 206 to/from its docked position. As shown in FIG. 2C-2D, spray head 206 may be configured to be gripped/held in a plurality of ways. For example, a user may grip with a limited number of fingers, as shown in FIG. 2C. In some embodiments, a user may grip spray head 206 in a partial fist, as shown in FIG. 2D. Spray head 206 may be sized/dimensioned such that a user may easily manipulate/grip the device in their preferred manner, not limited to those shown in FIGS. 2C-2D.

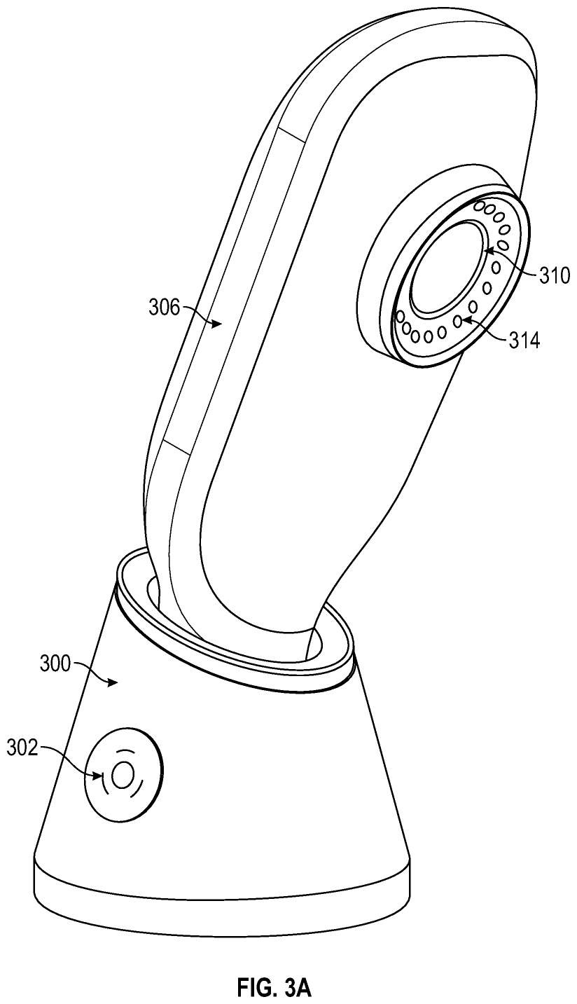

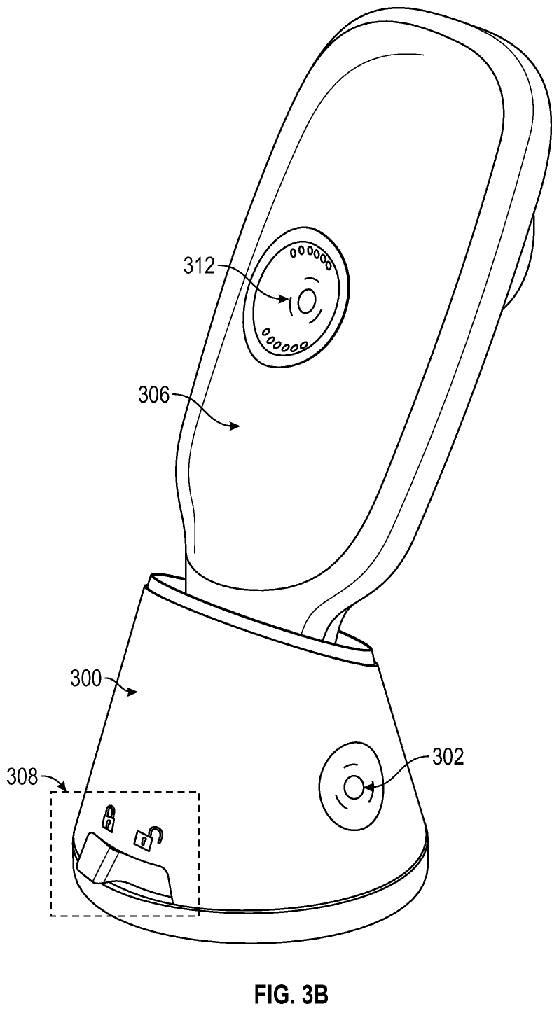

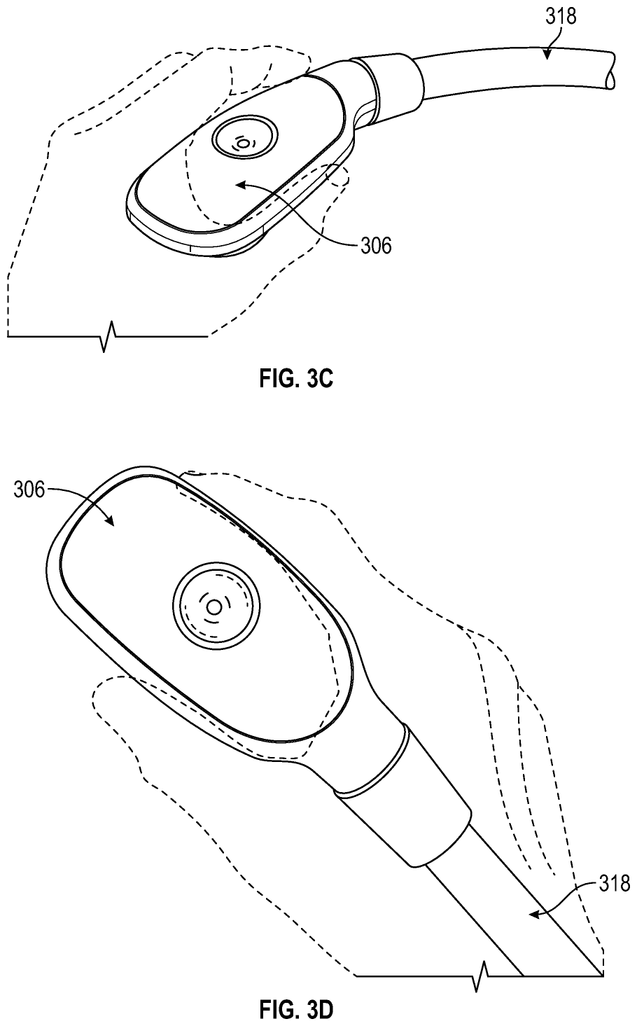

FIGS. 3A-3B show perspective views of an additional side sprayer 300 for dispensing active oxygen water. Side sprayer 300 may comprise any one or more features of side sprayer 200 described with respect to FIGS. 2A-2D. In some embodiments, side sprayer 300 may comprise controller 302, spray head 306, illuminator 310, and water outlet 314. Side sprayer 300 may comprise any one or more materials as described above with respect to side sprayer 200, for example, stainless steel, zinc, polymers, engineering thermoplastic, etc.

In some embodiments, controller 302 may comprise any one or more features of controller 102, 202 described above with respect to FIGS. 1A-1B and/or FIGS. 2A-2B. In some embodiments, illuminator 310 may comprise any one or more features of illuminator 110, 210 described above with respect to FIGS. 1B-1C and/or FIGS. 2A-2B. In some embodiments, water outlet 314 may comprise any one or more features of water outlet 114, 214 described above with respect to FIGS. 1C-1E and/or FIG. 2A. In some embodiments, side sprayer 300 may be configured to dispense water additionally or instead in a single-stream mode, as described above with respect to side sprayer 200 and/or faucet body 100.

In some embodiments, spray head 306 may comprise any one or more features of spray head 106, 206 described above with respect to FIGS. 1A-1E and/or FIGS. 2A-2D. In some embodiments, spray head 306 may comprise an oblong (e.g., “fin”) shape; for example, as shown in FIG. 3A, spray head 306 may comprise a partially oval and/or rectangular shape, such that spray head 306 comprises one or more rounded surfaces and/or rounded edges. In some embodiments, at least a portion of spray head 306 (e.g., the border of spray head 306) may comprise a secondary material (e.g., silicone) configured to provide grip for a user when holding spray head 306. In some embodiments, spray head 306 may be dimensioned and/or shaped such that a user may easily engage with and grip spray head 306, as will be described in greater detail with respect to FIGS. 3C-3D.

In some embodiments, spray head 306 may comprise a water outlet 314 on a front surface of the spray head, wherein the front surface faces a kitchen sink. The water outlet 314 may be accentuated (e.g., offset from) the remaining front surface of spray head 306. In some embodiments, the accentuated water outlet 314 of spray head 306 may be circular. In some embodiments, a face of the accentuated water outlet 314 of spray head 306 may be concave (e.g., inwards towards a surface of spray head 306 or outwards away from a surface of spray head 306).

In some embodiments, the docking station (e.g., base) of side sprayer 300 may comprise a conical shape, as illustrated in FIG. 3A. As described above with respect to the docking station of side sprayer 200, the base may comprise any shape (e.g., cylindrical, rectangular, triangular, polygonal, etc.). In some embodiments, the docking station of side sprayer 300 may comprise an angled top portion, such that a first side (e.g., back side, away from the kitchen sink) of the docking station may have a greater height than a second side (e.g., front side, toward the kitchen sink) of the docking station. In some embodiments, controller 302 may be disposed on a front, back, or side portion of the docking station of side sprayer 300.

FIG. 3B illustrates a portion of side sprayer 300 opposite the water outlet on spray head 306. As shown, side sprayer 300 may additionally comprise a touch-sensitive controller 312 and lock 308. Lock 308 may comprise any one or more features of lock 108, 208 described above with respect to FIGS. 1B, 2B above. Likewise, touch-sensitive controller 312 may comprise any one or more features of touch-sensitive controller 112, 212, and/or button 116 described above with respect to FIGS. 1B, 1D, and/or 2A. For example, touch-sensitive controller 312 may comprise one or more buttons, switches, dials, pressure sensors, capacitive touch sensors, etc. In some embodiments, touch-sensitive controller 312 may be disposed on a back surface of spray head 306. In some embodiments, touch-sensitive controller 312 may be centrally located on a back side of spray head 306, as shown in FIG. 3B. In some embodiments, touch-sensitive controller 312 may instead be located on a lower portion, upper portion, front side, edge, etc. of spray head 306 and/or side sprayer 300. In some embodiments, touch-sensitive controller 312 may be shaped as a circle, triangle, square, polygon, etc., and one or more portions of touch-sensitive controller 312 may be accentuated such that a user may easily recognize and engage with touch-sensitive controller 312. For example, as shown in FIG. 3B, touch-sensitive controller 312 may concave inward toward a surface of spray head 306.

FIGS. 3C-3D show various views of a user engaging with spray head 306 of side sprayer 300. In some embodiments, spray head 306 may be configured to be operably removed from the docking station (e.g., base) of side spray 300 such that a user may direct a stream of water from the water outlet of spray head 306 in a plurality of directions towards the kitchen sink. Spray head 306 may be fluidly connected to a hose 318, such that hose 318 has slack and can be extended from and/or retracted from the docking station of side sprayer 300 when a user removes and replaces spray head 306 to/from its docked position. As shown in FIG. 3C-3D, spray head 306 may be configured to be gripped/held in a plurality of ways. For example, a user may grip spray head 306 from a distal side opposite hose 318, such that a portion of the spray head 306 may rest within the user's hand and the user's fingers may extend along the longer edges of the oblong-shaped spray head 306. In some embodiments, a user may grip the spray head 306 from a proximal side fluidly connected with hose 318 (e.g., bottom portion), such that the bottom portion of the spray head 306 may rest within a user's hand and the user's fingers may extend along the longer edges of the oblong-shaped spray head 306 towards a top portion of the device. Spray head 306 may be dimensioned/sized such that a user may easily manipulate/grip the device in their preferred manner, not limited to those illustrated in FIGS. 3C-3D.

### System for Dispensing Active Oxygen Water

FIG. 4 shows a system diagram 400 for an active oxygen water dispenser (e.g., faucet body 100, side sprayer 200, side sprayer 300) configured to dispense active oxygen water and/or tap water. System 400 may comprise an active oxygen water dispenser (e.g., faucet body 100, side sprayer 200, side sprayer 300, etc.), one or more mixing valves 424, a treatment valve 426, an ozone generator 428, a cold water supply 430, and a hot water supply 432. In some embodiments, system 400 may comprise a wireless network by which a remote server 436 and a personal computing device 434 may communicate with the active oxygen water dispenser. In some embodiments, the active oxygen water dispenser may comprise a controller 402 (e.g., controller 102, 202, and/or 302), handle 404 (e.g., handle 104), lock 408 (e.g., lock 108, 208, and/or 308), illuminator 410 (e.g., illuminator 110, 210, and/or 310), processor 420, and receiver 422. As shown, each of the components of the active oxygen water dispenser may be communicatively coupled (e.g., via one or more wired and/or wireless connections). For purposes of illustration, controller 402 may comprise a touch-sensitive controller (e.g., touch-sensitive controller 112, 212, and/or 312) and/or button (e.g., button 116); however, with respect to the physical embodiments of active oxygen water dispensers 100, 200, and/or 300, the touch-sensitive controller may be disposed within the controller and/or in a portion of the active oxygen water dispenser distinct from the controller.

By way of example, system 400 is illustrated with a single mixing valve 424, treatment valve 426, processor 420, receiver 422, remote server 436, and personal computing device 434. However, each of the components of system 400 may be embodied by a plurality of components. For example, the active oxygen water dispenser may comprise a plurality of processors 420 and/or receivers 422. In some embodiments, in addition to or instead of the one or more processors 420, system 400 may comprise a set of wired electrical switches. For example, electrical switches may be associated with lock 408 and/or handle 404 to allow/disallow the flow of active oxygen water based on a user input detected at controller 402. The one or more receivers 422 may receive control signals with instructions from a personal computing devices 434 (e.g., mobile device, desktop, etc.), remote controller, control pad, dial, button, etc. to modify the capacitive field strength. The active oxygen water dispenser may be fluidly connected to a plurality of valves. For example, as mentioned above, system 400 may comprise a treatment valve 426 (e.g., solenoid valve) fluidly connected to the ozone generator 428 and at least a cold water supply 430. System 400 may additionally comprise one or more mechanical mixing valves 424 (e.g., cartridge valves) coupled to the handle 404 and fluidly connected to a cold and hot water supply 430, 432. System 400 may comprise one or more power supplies (e.g., batteries, wired plugs, etc.) configured to provide power to at least ozone generator 428 and/or one or more components of the active oxygen water dispenser (e.g., controller 402, illuminator 410, etc.), which is not illustrated in FIG. 4 but would be understood by one of ordinary skill in the art to be a requirement of the system.

In some embodiments, a user may provide instructions comprising a control setting (e.g., a capacitive field strength setting) via personal computing device 434, and the instructions may transmitted as a signal received at receiver 422. Receiver 422 may be configured to communicate the instructions to one or more components of the active oxygen water dispenser (e.g., processor 420 and/or controller 402) to modify the active oxygen water dispenser based on the provided control setting. In some embodiments, the control setting may be received at receiver 422 as a signal with an instruction indicative of one or more user settings, and the receiver may be configured to transmit signals to the one or more components of the active oxygen water dispenser based on the instructions. In some embodiments, rather than receiver 422 communicating to each respective component of the active oxygen water dispenser, processor 420 may be configured to receive and translate the signal from receiver 422 and may transmit one or more signals to the relevant components of the active oxygen water dispenser. In some embodiments, a set of electrical switches communicatively coupled to receiver 422 may transmit one or more signals to one or more components of the active oxygen water dispenser based on the instructions. In some embodiments, once the one or more components of the active oxygen water dispenser are updated (e.g., the capacitive field strength setting is modified based on the user input), processor 420 may be configured to communicate a notification to the personal computing device 434. In some embodiments, a user's preferred control setting (e.g., capacitive field strength) for operating the active oxygen water dispenser may be stored, for example in remote server 436.

In some embodiments, processor 420 may receive signals from one or more components of the active oxygen water dispenser (e.g., lock 408, controller 402, handle 404) and may, based on the input, cause one or outputs to occur. For example, processor 420 may receive a signal from lock 408 based on the lock being moved from a locked to an unlocked position. Based on the lock 408 being in an unlocked position, processor 420 may be configured to activate an ozone generator 428. In some embodiments, processor 420 may receive a signal indicative of the locking setting of lock 408 and may transmit a signal to illuminator 410 of the active oxygen water dispenser to communicate to a user the status of the lock. As mentioned above, one or more configurations of processor 420 may additionally or instead be embodied in a set of wired electrical switches, in some embodiments. For example, wired electrical switches associated with lock 408 may be configured to allow/disallow flow of an active oxygen water supply. In some embodiments, system 400 may comprise a combination of wired electrical switches and processor(s) 420. For example, one or more electrical switches may be coupled to ozone generator 428 and processor 420 to allow/disallow ozonation of a cold water supply.

In some embodiments, processor 420 may be configured to receive a signal based on an input received at controller 402. In some embodiments, the signal may be indicative of a request to activate the active oxygen water supply. Based on the received signal (and in accordance with the locking setting of lock 408), processor 420 may actuate one or more treatment valves 426 (e.g., a solenoid valve), the treatment valve 426 fluidly connected at least to a cold water supply 430. In some embodiments, system 400 may comprise one or more valve actuators communicatively coupled to processor 420 and one or more valves (e.g., treatment valve 426, mixing valve 424) and configured to actuate the valves, rather than processor 420 directly actuating the valves. In some embodiments, processor 420 may additionally activate an ozone generator 428. In some embodiments, the one or more treatment valves 426 in fluid connection with ozone generator 428 may be configured to delay providing a water supply from the cold water supply 430 to the active oxygen water dispenser until an ozone-infused water supply is produced with ozone generator 428. In some embodiments, processor 420 may be configured to transmit a signal to one or more illuminators 410 to communicate that active oxygen water is ready to be dispensed and/or is currently being dispensed.

In some embodiments, a user may engage with handle 404 to dispense unenhanced water when active oxygen water is presently being dispensed. Processor 420 may receive a signal from handle 404 and transmit one or more signals to deactivate ozone generator 428. In some embodiments, handle 404 may be coupled to a mechanical mixing valve 424 to control the volume and temperature of tap water being dispensed. In some embodiments, a user may engage with lock 408 (e.g., move lock 408 from an unlocked to a locked setting) while active oxygen water is being dispensed from the active oxygen water dispenser. Processor 420 may receive a signal from lock 408 based on the updated setting and may transmit one or signal to deactivate an ozone generator 428 to dispense tap water. In some embodiments, one or more electrical switches communicatively coupled at least to handle 404 and ozone generator 428 may cause ozone generator 428 to deactivate based on an engagement with handle 404.

In some embodiments, processor 420 may receive one or more inputs from a controller 402 (e.g., one or more touch-sensitive controllers on the fluid dispenser) indicative of a request to change the water outlet at which water (e.g., active oxygen water or tap water) is being dispensed. For example, an active oxygen water supply may be presently dispensed in a shower spray mode. Based on the input, the processor 420 may modify the mode at which water is being dispensed to a single-stream mode.

In some embodiments, processor 420 may receive a second signal from controller 402 while active oxygen water is being dispensed, the signal indicative of a user request to deactivate the active oxygen water supply. Based on the user input, processor 420 may transmit one or more signals to ozone generator 428 and one or more treatment valves 426 to deactivate the active oxygen water supply being dispensed from the active oxygen water dispenser. Processor 420 may communicate the status of the device via illuminator 410.

The foregoing description sets forth exemplary systems, methods, techniques, parameters, and the like. It should be recognized, however, that such description is not intended as a limitation on the scope of the present disclosure but is instead provided as a description of exemplary embodiments.

Although the description herein uses terms first, second, etc. to describe various elements, these elements should not be limited by the terms. These terms are only used to distinguish one element from another.

### EMBODIMENTS

Embodiment 1. A faucet for dispensing active oxygen water, comprising:
a faucet body comprising a lock, a water outlet, and a controller, wherein the lock is disposed on a first portion of the faucet body, and the controller is disposed on the first portion of the faucet body and configured to detect a user input requesting active oxygen water to be dispensed from the faucet body; and
one or more valves fluidly connected to the faucet body and configured to allow an active oxygen water supply to be dispensed, wherein, when the lock is in an unlocked position and the controller detects the user input, the one or more valves is actuated to an open position to allow the faucet body to dispense the active oxygen water supply from the water outlet.

Embodiment 2. The faucet of embodiment 1, comprising one or more processors communicatively coupled to the controller and the lock and configured to cause the one or more valves to be actuated to the open position when the one or more processors receive a signal indicating the user input and the lock is in the unlocked position.

Embodiment 3. The faucet of embodiment 1 or 2, wherein the one or more valves are actuated to a closed position when the controller detects a second user input requesting active oxygen water to stop being dispensed.

Embodiment 4. The faucet of embodiment 3, comprising one or more processors configured to cause the one or more valves to be actuated to the closed position when the one or more processors receive a signal indicating the second user input.

Embodiment 5. The faucet of any one of embodiments 1-4, wherein the controller comprises one or more capacitive sensors.

Embodiment 6. The faucet of embodiment 5, comprising one or more receivers configured to receive a control signal comprising an instruction to adjust a capacitive field strength setting of a capacitive field generated at least in part by the one or more capacitive sensors.

Embodiment 7. The faucet of embodiment 5 or 6, wherein the capacitive field is adjustable between a high, medium, and low capacitive field strength setting.

Embodiment 8. The faucet of embodiment 7, wherein the controller is touch-sensitive and configured to receive the user input at least when the capacitive field strength setting is adjusted to the low setting.

Embodiment 9. The faucet of embodiment 7 or 8, wherein the controller is touchless and configured to receive the user input as a hands-free interaction at a first distance from the controller when the capacitive field strength setting is adjusted to the medium setting.

Embodiment 10. The faucet of embodiment 9, wherein the controller is touchless and configured to receive the user input as the hands-free interaction at a second distance from the controller when the capacitive field strength setting is adjusted to the high setting, wherein the second distance is larger than the first distance.

Embodiment 11. The faucet of any one of embodiments 1-10, wherein the lock is a dial adjustable between the unlocked position and a locked position.

Embodiment 12. The faucet of any one of embodiments 1-11, comprising one or more illuminators disposed on at least the first portion of the faucet body.

Embodiment 13. The faucet of embodiment 12, wherein the one or more illuminators are configured to illuminate a first color when the lock is in the unlocked position and a second color when the lock is in a locked position.

Embodiment 14. The faucet of any one of embodiments 1-13, wherein the faucet body is fluidly connected to an ozone generator configured to add ozone gas to a cold water supply to generate the active oxygen water supply.

Embodiment 15. The faucet of embodiment 14, comprising one or more processors configured to cause the ozone generator to be activated to generate the active oxygen water supply when the one or more processors receive a signal indicating the user input and the lock is in the unlocked position.

Embodiment 16. The faucet of any one of embodiments 1-15, wherein the faucet body comprises a removably docked spray head comprising the water outlet.

Embodiment 17. The faucet of embodiment 16, wherein the active oxygen water supply is dispensed from the water outlet of the spray head in a shower spray mode.

Embodiment 18. The faucet of any one of embodiments 1-17, comprising a handle disposed on a second portion of the faucet body, wherein the second portion is opposite from the first portion, and the handle is configured to cause a mixing valve of the one or more valves to be actuated to an open position to allow the faucet body to dispense a tap water supply from the water outlet.

Embodiment 19. The faucet of embodiment 18, comprising an ozone generator configured to be deactivated when the handle is engaged to allow the faucet body to dispense the tap water supply from the water outlet.

Embodiment 20. The faucet of any one of embodiments 1-19, wherein the controller is cylindrical and disposed on the first portion of the faucet body such that a circular face of the cylindrical controller is perpendicular to the faucet body.

Embodiment 21. A side sprayer for dispensing active oxygen water, comprising:
a side spray docking station and a spray head, wherein the spray head comprises a water outlet, and the side spray docking station comprises:
a controller disposed on a first portion of the side spray docking station and configured to detect a user input requesting active oxygen water to be dispensed from the spray head; and
a lock disposed on a second portion of the side spray docking station; and
one or more valves fluidly connected to the spray head and configured to allow an active oxygen water supply to be dispensed, wherein, when the lock is in an unlocked position and the controller detects the user input, the one or more valves is actuated to an open position to allow the spray head to dispense the active oxygen water supply from the water outlet.

Embodiment 22. The side sprayer of embodiment 21, comprising one or more processors communicatively coupled to the controller and configured to cause the one or more valves to be actuated to the open position when the one or more processors receive a signal indicating the user input and the lock is in the unlocked position.

Embodiment 23. The side sprayer of embodiment 21 or 22, wherein the one or more valves are actuated to a closed position when the controller detects a second user input requesting active oxygen water to stop being dispensed.

Embodiment 24. The side sprayer of embodiment 23, comprising one or more processors configured to cause the one or more valves to be actuated to the closed position when the one or more processors receive a signal indicating the second user input.

Embodiment 25. The side sprayer of any one of embodiments 21-24, wherein the controller comprises one or more capacitive sensors.

Embodiment 26. The side sprayer of embodiment 25, comprising one or more receivers configured to receive a control signal comprising an instruction to adjust a capacitive field strength setting of a capacitive field generated at least in part by the one or more capacitive sensors.

Embodiment 27. The side sprayer of embodiment 25 or 26, wherein the capacitive field is adjustable between a high, medium, and low capacitive field strength setting.

Embodiment 28. The side sprayer of embodiment 27, wherein the controller is touch-sensitive and configured to receive the user input at least when the capacitive field strength setting is adjusted to the low setting.

Embodiment 29. The side sprayer of embodiment 27 or 28, wherein the controller is touchless and configured to receive the user input as a hands-free interaction at a first distance from the controller when the capacitive field strength setting is adjusted to the medium setting.

Embodiment 30. The side sprayer of embodiment 29, wherein the controller is touchless and configured to receive the user input as the hands-free interaction at a second distance from the controller when the capacitive field strength setting is adjusted to the high setting, wherein the second distance is larger than the first distance.

Embodiment 31. The side sprayer of any one of embodiments 21-30, wherein the lock is a switch adjustable between the unlocked position and a locked position.

Embodiment 32. The side sprayer of any one of embodiments 21-31, comprising one or more illuminators disposed on at least a portion of the spray head.

Embodiment 33. The side sprayer of embodiment 32, wherein the one or more illuminators are configured to illuminate a first color when the lock is in the unlocked position and a second color when the lock is in a locked position.

Embodiment 34. The side sprayer of any one of embodiments 21-33, wherein the spray head is fluidly connected to an ozone generator configured to add ozone gas to a cold water supply to generate the active oxygen water supply.

Embodiment 35. The side sprayer of embodiment 34, comprising one or more processors configured to cause the ozone generator to be activated to generate the active oxygen water supply when the one or more processors receive a signal indicating the user input and the lock is in the unlocked position.

Embodiment 36. The side sprayer of any one of embodiments 21-35, wherein the spray head is removably docked on the side spray docking station.

Embodiment 37. The side sprayer of any one of embodiments 21-36, wherein the active oxygen water supply is dispensed from the water outlet of the spray head in a shower spray mode.

Embodiment 38. The side sprayer of any one of embodiments 21-37, comprising a touch-sensitive controller disposed on a portion of the spray head opposite the water outlet and configured to detect the user input requesting active oxygen water to be dispensed from the spray head.

Embodiment 39. The side sprayer of embodiment 38, comprising one or more processors communicatively coupled to the touch-sensitive controller and configured to cause the one or more valves to be actuated to the open position when the one or more processors receive a signal indicating the user input and the lock is in the unlocked position.

1. A faucet for dispensing active oxygen water, comprising:
a faucet body comprising a lock, a water outlet, and a controller, wherein the lock is disposed on a first portion of the faucet body, and the controller is disposed on the first portion of the faucet body and configured to detect a user input requesting active oxygen water to be dispensed from the faucet body; and
one or more valves fluidly connected to the faucet body and configured to allow an active oxygen water supply to be dispensed, wherein, when the lock is in an unlocked position and the controller detects the user input, the one or more valves is actuated to an open position to allow the faucet body to dispense the active oxygen water supply from the water outlet.

2. The faucet of claim 1, comprising one or more processors communicatively coupled to the controller and the lock and configured to cause the one or more valves to be actuated to the open position when the one or more processors receive a signal indicating the user input and the lock is in the unlocked position.

3. The faucet of claim 1, wherein the one or more valves are actuated to a closed position when the controller detects a second user input requesting active oxygen water to stop being dispensed.

4. The faucet of claim 3, comprising one or more processors configured to cause the one or more valves to be actuated to the closed position when the one or more processors receive a signal indicating the second user input.

5. The faucet of claim 1, wherein the controller comprises one or more capacitive sensors.

6. The faucet of claim 5, comprising one or more receivers configured to receive a control signal comprising an instruction to adjust a capacitive field strength setting of a capacitive field generated at least in part by the one or more capacitive sensors.

7. The faucet of claim 6, wherein the capacitive field is adjustable between a high, medium, and low capacitive field strength setting.

8. The faucet of claim 7, wherein the controller is touch-sensitive and configured to receive the user input at least when the capacitive field strength setting is adjusted to the low setting.

9. The faucet of claim 7, wherein the controller is touchless and configured to receive the user input as a hands-free interaction at a first distance from the controller when the capacitive field strength setting is adjusted to the medium setting.

10. The faucet of claim 9, wherein the controller is touchless and configured to receive the user input as the hands-free interaction at a second distance from the controller when the capacitive field strength setting is adjusted to the high setting, wherein the second distance is larger than the first distance.

11. The faucet of claim 1, wherein the lock is a dial adjustable between the unlocked position and a locked position.

12. The faucet of claim 1, comprising one or more illuminators disposed on at least the first portion of the faucet body.

13. The faucet of claim 12, wherein the one or more illuminators are configured to illuminate a first color when the lock is in the unlocked position and a second color when the lock is in a locked position.

14. The faucet of claim 1, wherein the faucet body is fluidly connected to an ozone generator configured to add ozone gas to a cold water supply to generate the active oxygen water supply.

15. The faucet of claim 14, comprising one or more processors configured to cause the ozone generator to be activated to generate the active oxygen water supply when the one or more processors receive a signal indicating the user input and the lock is in the unlocked position.

16. The faucet of claim 1, wherein the faucet body comprises a removably docked spray head comprising the water outlet.

17. The faucet of claim 16, wherein the active oxygen water supply is dispensed from the water outlet of the spray head in a shower spray mode.

18. The faucet of claim 1, comprising a handle disposed on a second portion of the faucet body, wherein the second portion is opposite from the first portion, and the handle is configured to cause a mixing valve of the one or more valves to be actuated to an open position to allow the faucet body to dispense a tap water supply from the water outlet.

19. The faucet of claim 18, comprising an ozone generator configured to be deactivated when the handle is engaged to allow the faucet body to dispense the tap water supply from the water outlet.

20. The faucet of claim 1, wherein the controller is cylindrical and disposed on the first portion of the faucet body such that a circular face of the cylindrical controller is perpendicular to the faucet body.

21. A side sprayer for dispensing active oxygen water, comprising:
a side spray docking station and a spray head, wherein the spray head comprises a water outlet, and the side spray docking station comprises: a controller disposed on a first portion of the side spray docking station and configured to detect a user input requesting active oxygen water to be dispensed from the spray head; and a lock disposed on a second portion of the side spray docking station; and
one or more valves fluidly connected to the spray head and configured to allow an active oxygen water supply to be dispensed, wherein, when the lock is in an unlocked position and the controller detects the user input, the one or more valves is actuated to an open position to allow the spray head to dispense the active oxygen water supply from the water outlet.
